(19) United States
(12) Patent Application Publication
(10) Pub. No.: US 2002/0184326 A1
(43) Pub. Date: Dec. 5, 2002

(54) System and method for providing network interfaces to instruments without networking capabilities

(76) Inventor: Andrew Thomson, Austin, TX (US)

Correspondence Address: Jeffrey C. Hood, Conley, Rose, & Tayon, P.C., P.O. Box 398, Austin, TX, 78767, US

(21) Appl. No.: 09/872,300

(22) Filed: May 31, 2001

(51) Int. Cl. G06F 15/16

(52) U.S. Cl. 709/208; 709/250; 700/90

(57) ABSTRACT

A system and method for providing web server capabilities for existing instruments without inherent networking capabilities. A server device may comprise an instrument server. The instrument server may communicate with instruments connected to the server device via an instrumentation bus. The instrument server may detect the instruments connected to the instrumentation bus. A client system may connect to the instrument server via a network (e.g. the Internet). The instrument server may provide a graphical user interface to the client system to allow the instruments to be selected, controlled and/or monitored remotely from the client system via the network. In one embodiment, the client system comprises a web browser, and the interface comprises one or more web pages for controlling instruments and for displaying data received from the instruments.

### FIELD OF THE INVENTION

The present invention relates to the field of virtual instrumentation, and more particularly to a system and method for providing network interfaces to instruments without inherent networking capabilities.

### DESCRIPTION OF THE RELATED ART

The Internet has opened many new opportunities and uses for personal computers and workstations across every industry and application area. Scientists and engineers are finding that important functions can be performed across the Internet, such as research, publishing conclusions, displaying data across the web, or even controlling source code versions and tracking for test development teams.

One important application of the Internet is in the field of instrumentation, and more specifically virtual instrumentation. For example, a computer-based virtual instrument may be created which includes web server technology for publishing data on the Internet. This allows remote users to monitor and control a virtual instrument from a remote location. For example, National Instruments sells an Internet Developers Toolkit, which allows a user to easily incorporate a variety of electronic communications capabilities, such as e-mail, FTP transfers, or the WWW into virtual instrumentation applications.

However, many traditional instruments are in use which cannot take advantage of Internet web capabilities. For example, many traditional “box instruments” are in use which do not have any inherent Web server or Internet communications. These box instruments cannot inherently publish data to the Internet or receive command instructions from the Internet.

Instrumentation

An instrument is a device which collects data or information from an environment or unit under test and displays this information to a user. An instrument may also perform various data analysis and data processing on acquired data prior to displaying the data to the user. Examples of various types of instruments include oscilloscopes, digital multimeters, pressure sensors, machine vision systems, motion control systems, etc., and the types of information which might be collected by respective instruments include voltage, resistance, distance, velocity, pressure, frequency of oscillation, humidity, temperature, image data, video data, and audio data among others.

In the past, many instrumentation systems comprised individual instruments physically interconnected with each other. Each instrument typically included a physical front panel with its own particular combination of indicators, knobs, or switches. A user generally had to understand and manipulate individual controls for each instrument and record readings from an array of indicators. Acquisition and analysis of data in such instrumentation systems was tedious and error prone.

Computer Control of Instruments

A significant advance occurred with the introduction of computers to provide more flexible means for interfacing instruments with a user. In such computerized instrumentation systems, the user interacts with software executing on the computer system through the computer's video monitor rather than through a manually operated front panel to control one or more real world instruments. The software executing on the computer system can be used to simulate the operation of an instrument in software or to control or communicate with one or more real world instruments, these software created/controlled instruments being referred to as virtual instruments.

Therefore, modern instrumentation systems are moving from dedicated standalone hardware instruments such as oscilloscopes, digital multimeters, etc., to a concept referred to as virtual instrumentation. Virtual instrumentation comprises general-purpose personal computers and workstations combined with instrumentation software and hardware to build a complete instrumentation system. In a virtual instrumentation system, a virtual instrument operating on a central computer controls the constituent instruments from which it acquires data which it analyzes, stores, and presents to a user of the system. Computer control of instrumentation has become increasingly desirable in view of the increasing complexity and variety of instruments available for use, and computerized instrumentation systems provide significant performance efficiencies over earlier systems for linking and controlling test instruments.

The various hardware interface options currently available for instrumentation systems can be categorized into various types, including IEEE 488-controlled instruments (GPIB instruments), VXI bus instruments, plug-in data acquisition (DAQ) boards, PCI bus and PXI bus instruments, and serial instruments, such as RS-232-controlled, USB (Universal Serial Bus), or IEEE 1394 (FireWire) instruments, among others. Background on these various hardware interface options is deemed appropriate. The GPIB (general-purpose interface bus) began as a bus designed by Hewlett-Packard in 1965, referred to as the Hewlett-Packard Interface Bus (HPIB), to connect their line of programmable instruments to their computers. National Instruments Corporation expanded the use of this bus to computers manufactured by companies other than Hewlett-Packard and hence the name General Purpose Interface Bus (GPIB) became more widely used than HPIB. The GPIB interface bus gained popularity due to its high transfer rates and was later accepted as IEEE standard 488-1975, and the bus later evolved to ANSI/IEEE standard 488.1-1987. In order to improve on this standard, two new standards were drafted, these being ANSI/IEEE 488.2-1987 and the SCPI (Standard Commands for Programmable Instruments) standard. The IEEE 488.2 standard strengthened the original standard by defining precisely how controllers and instruments communicated. The IEEE 488.2 standard removed ambiguities of the IEEE 488.1 standard by defining data formats, status reporting, a message exchange protocol, IEEE 488.2 controller requirements, and common configuration commands to which all IEEE 488.2 instruments must respond in a precise manner. Thus, the IEEE 488.2 standard created more compatible, more reliable systems that were simpler to program. The Standard Commands for Programmable Instruments (SCPI) standard uses the command structures defined in the IEEE 488.2 standard and forms a single, comprehensive programming command set that is used with any SCPI instrument. The SCPI standard simplified the programming process for manufacturers and users alike. Rather than having to learn a different command set for each instrument, the user could focus on solving the measurement tests of his or her application, thus decreasing programming time.

The VXI (VME eXtension for Instrumentation) bus is a platform for instrumentation systems that was first introduced in 1987 and was originally designed as an extension of the VME bus standard. The VXI standard has experienced tremendous growth and acceptance around the world and is used in a wide variety of traditional test and measurement and ATE applications. The VXI standard uses a mainframe chassis with a plurality of slots to hold modular instruments on plug-in boards. The VXI architecture is capable of interfacing with both message-based instruments and register-based instruments. A message-based instrument is an instrument which is controlled by a string of ASCII characters, whereas a register-based instrument is controlled by writing a bit stream of 1's and 0's directly to registers in the instrument hardware.

An instrumentation system using a data acquisition interface method typically includes transducers which sense physical phenomena from the process or unit under test and provide electrical signals to data acquisition hardware inside the computer system. The electrical signals generated by the transducers may be converted into a form that the data acquisition board can accept, typically by signal conditioning logic positioned between the transducers and the data acquisition device or card in the computer system. The data acquisition device or card may include analog to digital (A/D) conversion logic for converting received analog signals into digital signals that the computer can understand.

PCI (Peripheral Component Interconnect) bus instruments and PXI (PCI extensions for Instrumentation) instruments leverage off of the PCI bus found in mainstream computer systems. These instruments include a connector which is electrically compatible with the PCI bus. “Desktop PCI” instruments have a conventional PCI form factor for use in desktop PCs. The PXI instrumentation bus standard, promulgated by National Instruments, includes a CompactPCI mechanical form factor, is electrically compatible with the PCI bus, and includes extra signal definitions for instrumentation purposes.

A computer can also control an instrumentation system through a serial connection, such as the computer's serial or RS-232 port, the USB (Universal Serial Bus), or the IEEE 1394 or 1394.2 High Performance Serial Bus, referred to as FireWire. There are currently thousands of instruments with an RS-232 interface.

The software architecture for an instrumentation system, such as a virtual instrumentation system, comprises several components. The top level of the software architecture typically comprises an application program used for high-level control of the virtual instrument. Examples of high-level application programs for instrumentation control are LabVIEW, LabWindows\CVI, and ComponentWorks from National Instruments Corp. Other examples of applications programs are HP VEE from Hewlett-Packard and DasyLab from DasyTec GMBH, among others. These application programs provide a user with the tools to control instruments, including acquiring data, analyzing data, and presenting data.

The application programs mentioned above typically operate in conjunction with one or more instrument drivers to interface to actual physical instruments. For example, the LabVIEW and LabWindows application software each include instrument libraries comprising drivers for more than six hundred GPIB, VXI, and RS-232 instruments from numerous manufacturers. The instrument drivers are designed to reduce a user's application development time by providing intuitive high level functions that relieve the user of complex low level instrument programming.

A software level referred to as driver level software is below the instrument driver level. Driver level software is used to interface the commands in the instrument driver to the actual hardware interface being used, such as a GPIB interface card, a data acquisition card, or a VXI card. In other words, driver level software handles the details of communication, i.e., the transfer of commands and data, over a physical connection between the computer and instruments. There have been many implementations of I/O control software, some of which were custom-developed by end users, while others were developed by vendors and sold along with interface hardware. Examples of driver level software include NI-488, NI-DAQ, and NI-VXI driver level software offered by National Instruments, Inc., which have become de facto standards in the industry. Another example of driver level software is the Standard Instrument Control Library (SICL) offered by Hewlett-Packard and the VISA (Virtual Instrument Software Architecture) promulgated by the VXIplug&play Consortium.

FIG. 1 illustrates the historical evolution of instrument drivers. When IEEE 488.1 instruments were first introduced, standardized I/O libraries were provided which allowed users to provide strings to instruments. These standardized libraries include libraries for IEEE 488.1, IEEE 488.2 and the VISA I/O libraries. The progression from IEEE 488.1 to IEEE 488.2 and then to VISA represent a progression or evolution of the I/O libraries and how the user communicates with an instrument. However, each of these libraries generally still required the user to understand command strings and/or what registers were required to peek and poke within an application to control an instrument.

After the introduction of standardized I/O libraries, there was a movement to standardize the commands that users provided to instruments. This standardization of commands was referred to as SCPI (Standard Commands for Programming Instruments). As discussed above, SCPI allowed generic applications that worked with any of a plurality of instruments. In other words, each of the instruments accepted the same commands and behaved generically based on those commands. However, SCPI did not provide a sufficient number of commands to cover all the different types of instruments available. During this time, companies such as National Instruments and Hewlett Packard, among others, have been developing instrument drivers. Instrument drivers are custom written libraries of software that are specific to a given instrument. These instrument drivers encapsulate, at a high level, the commands that are required to communicate to a given instrument. These instrument drivers encapsulate all of the low level syntax and the order of operation that is required to send commands to an instrument, which can be very difficult and time consuming.

Examples of current prior art instrument drivers are those developed for LabVIEW and LabWindows/CVI. These instrument drivers present the user with a set of high-level functions that are easy to understand and use in their programs. The VXIplug&play consortium was formed to extend these instrument drivers. The VXIplug&play standard ensured that the user could install instrument drivers from a variety of vendors on one computer, and those instrument drivers would not conflict with each other. In other words, instrument drivers which conformed to the VXIplug&play standard would behave gracefully in a system comprising a plurality of instrument drivers supplied by a variety of vendors, thus providing system interoperability.

### SUMMARY OF THE INVENTION

The present invention comprises various embodiments of a system and method for providing web server capabilities for existing instruments without inherent networking capabilities. The system and method may also be used for instruments with inherent networking capabilities.

One embodiment of an instrument server system may include one or more instruments. These instruments may be traditional instruments (also called “box instruments) such as oscilloscopes, multimeters, signal analyzers, frequency analyzers and other types of instrument or measurement devices. A traditional or box instrument may be characterized by a chassis, typically having six sides, a physical front panel comprised on at least one side of the chassis, and vendor-defined instrument functionality contained within the chassis. The front panel or other parts of the chassis may include one or more physical controls such as knobs or switches for controlling various aspects of the instrument functionality. The front panel may also comprise one or more displays (e.g. CRT or LCD displays) for displaying instrument information and/or data either graphically or textually. Traditional instruments are not inherently capable of connecting to the Internet to display Web pages or to serve Web pages accessible from computer systems to display instrument data and/or control instrument functionality via the Internet.

One embodiment for providing Web server or Internet capabilities to a traditional or box instrument may comprise connecting the traditional instrument to a server device as described herein. The instrument(s) may couple to a server device via an instrumentation bus. Examples of instrumentation buses include the GPIB (General Purpose Interface Bus) or IEEE 488 or 488.2 buses, the VXI bus, the PCI bus, or a serial bus such as RS-232, USB or IEEE 1394. Each instrument may also be connected to one or more units under test (UUTs) to analyze, measure and/or control the UUTs. These instruments may not inherently have networking (e.g. Internet) capabilities. Hence, without use of the present invention, a user will not be able to access these instruments via a network (e.g. using the Internet).

The server device may include an instrument server program executable within the server device. The instrument server may connect to and communicate with the one or more instruments through the instrumentation bus. In one embodiment, the instrument server may communicate to an instrument through an instrument driver associated with the instrument. The instrument driver may perform all direct communications to the instrument over the instrumentation bus. In one embodiment, the instrument driver may provide an application programming interface (API) to the instrument server, and the instrument server may use the API to communicate with the instrument through the instrument driver.

The instrument server may operate to provide network server capabilities for the one or more instruments. The instrument server may connect to a network such as the Internet. A client system which may be executing a client web browser may access the instrument server through the network in order to monitor and/or control one or more of the respective instruments. The instrument server may connect to the network using any of a variety of protocols such as Ethernet, low level protocols that support TCP/IP, or other types of protocols. Thus, the web browser executing on the client system may be used to access the instrument server through the network. The instrument server may then communicate with the instruments coupled to the instrumentation bus trough the instrument driver(s) on behalf of the client system to control and/or monitor the instruments.

In one embodiment, the instrument driver may not previously exist on the server system. If an instrument driver does not exist on the server system for an instrument, an instrument driver for the instrument may be downloaded from another system on the network. An instrument driver for an instrument may be downloaded (or alternatively uploaded) from a client system, for example, one that has selected the particular instrument to monitor and/or control.

In one embodiment, when the client system accesses the instrument server, the instrument server may provide to the client system a user interface to the functionality of the instrument server. When a client system accesses the instrument server, the instrument server may provide information about the one or more instruments currently available on the instrumentation bus. The instrument server may scan the bus (for example, by polling the bus addresses) to locate and, if possible, obtain information about detected instruments. This instrument information may then be provided to the client system. In one embodiment, the instrument information may be displayed in one or more web pages on the client system. The instrument information may include identity information (e.g. manufacturer and model number) for the instruments. The instrument information may comprise one or more icons displayed on the client system, wherein each icon corresponds to an instrument. The user of the client system may then simply select the icon in order to communicate with or control the respective instrument.

On some instrumentation buses, it may not be possible to automatically acquire instrument information for at least some instruments connected to the instrumentation bus. In one embodiment, for instruments that can be detected but not identified, the instrument server may provide a mechanism that allows a user of the server device to identify the detected instruments. In one embodiment, the instrument server may provide a mechanism to allow a user of a client system to identify detected instruments. For example, a web page provided to the client system by the instrument server may provide one or more fields for the user to enter additional information about one or more detected instruments.

The instrument information displayed on the client system may be used to select one or more instruments to be monitored and/or controlled from client system. In one embodiment, each instrument may have associated instrument information, and the instrument information may include or be associated with a web link, for example, a Universal Resource Locator (URL), that may, when selected, access a web page or web pages associated with the particular instrument. To select the instrument, a user may select the web link associated with the instrument. Alternatively, as described above, a user may select an icon displayed on the client system to select a corresponding instrument.

When an instrument is selected from client system, the instrument server on the server device may provide to the client system one or more web pages as a user interface to the particular instrument. The one or more web pages may be displayed by the web browser on the client system. The one or more web pages may provide a virtual instrument graphical user interface (GUI) to the associated instrument. A user of client system may use the instrument GUI provided by the one or more web pages to monitor and/or control the activities of the associated instrument via the network.

On the Internet, a web page is typically a file notated with the Hypertext Markup Language (HTML), or alternatively with other markup languages. Typically, a web page includes text and specifications about where image or other multimedia files are to be placed when the page is displayed. Each web page is an individual markup language file with its own Web address (Uniform Resource Locator). The first page typically requested at a site is known as the home page.

One or more control functions of the instrument may be initiated from the client system using the instrument GUI provided by the instrument server. In one embodiment, the instrument GUI may graphically display one or more instrument controls that allow the instrument to be configured, calibrated, and to start data acquisition by the instrument. The instrument controls may be graphical controls and/or alphanumeric controls. For example, a web page may include a text entry box that allows text commands to be entered and sent to the instrument. As another example, a web page may include one or more graphical controls (e.g. dials, switches, sliding bars, etc.) that may be manipulated in the web page to generate control signals that may be sent to the instrument.

The instrument may send a portion or all of the acquired instrument data to the client system, or to another device or computer system, via the instrument server. The instrument may send the instrument data on the instrumentation bus. The instrument server then may access the instrument data from the instrumentation bus. The instrument server then may send a portion or all of the instrument data to the client system or to another device or computer system via the network. When the client system receives the instrument data, a portion or all of the instrument data may be displayed on the instrument GUI on the client system. In one embodiment, the instrument GUI may include one or more web pages displayed by the web browser on the client system, and may alphanumerically and/or graphically display the data in the one or more web pages. The one or more web pages may each include one or more display items for displaying portions or all of the data graphically and/or alphanumerically.

### BRIEF DESCRIPTION OF THE DRAWINGS

A better understanding of the present invention can be obtained when the following detailed description of the preferred embodiment is considered in conjunction with the following drawings, in which:

FIG. 1 illustrates the historical evolution of instrument drivers;

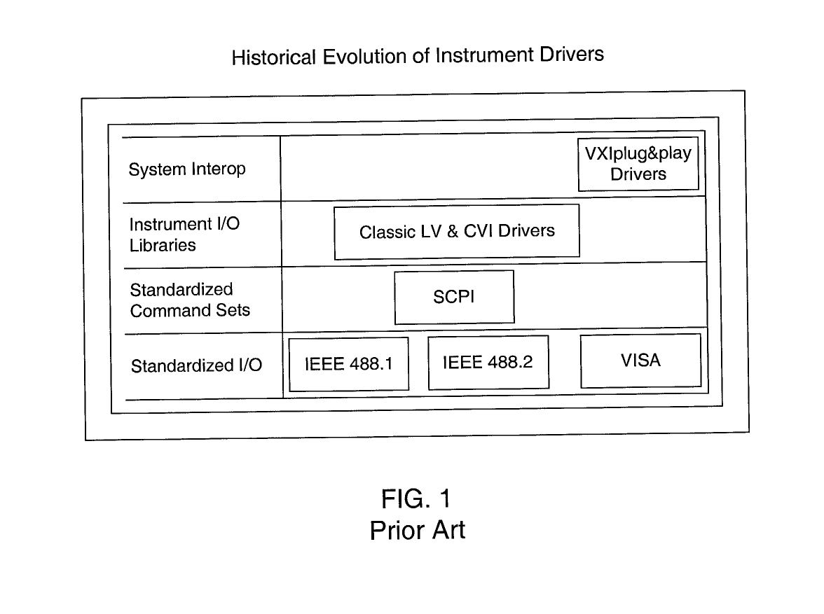

FIG. 2A illustrates an instrument server system with a computer system as the instrument server device according to one embodiment;

FIG. 2B illustrates an instrument server system with a stand-alone device as the instrument server device according to one embodiment;

FIG. 3 is a block diagram illustrating a client system accessing an instrument through an instrument server according to one embodiment;

FIGS. 4A through 4D illustrate an example of using an instrument server 144 to monitor and control the activities of one or more instruments 112 according to one embodiment;

FIG. 5 is a flowchart illustrating a method of connecting traditional instruments to client systems on a network using an instrument server according to one embodiment;

FIG. 6 is a flowchart illustrating a method of an instrument server providing information about instruments to a client system according to one embodiment;

FIG. 7 is a flowchart illustrating a method of using an instrument server to access instrument data over a network according to one embodiment; and

FIG. 8 is a flowchart illustrating a method of controlling and monitoring instruments over the network using an instrument server according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS OF THE INVENTION

Incorporation By Reference

The IEEE 488.1 specification and the IEEE 488.2 specification published by the IEEE are both hereby incorporated by reference in their entirety.

The NI-488 and NI-488.2 reference manuals, available from National Instruments Corporation, are hereby incorporated by reference in their entirety.

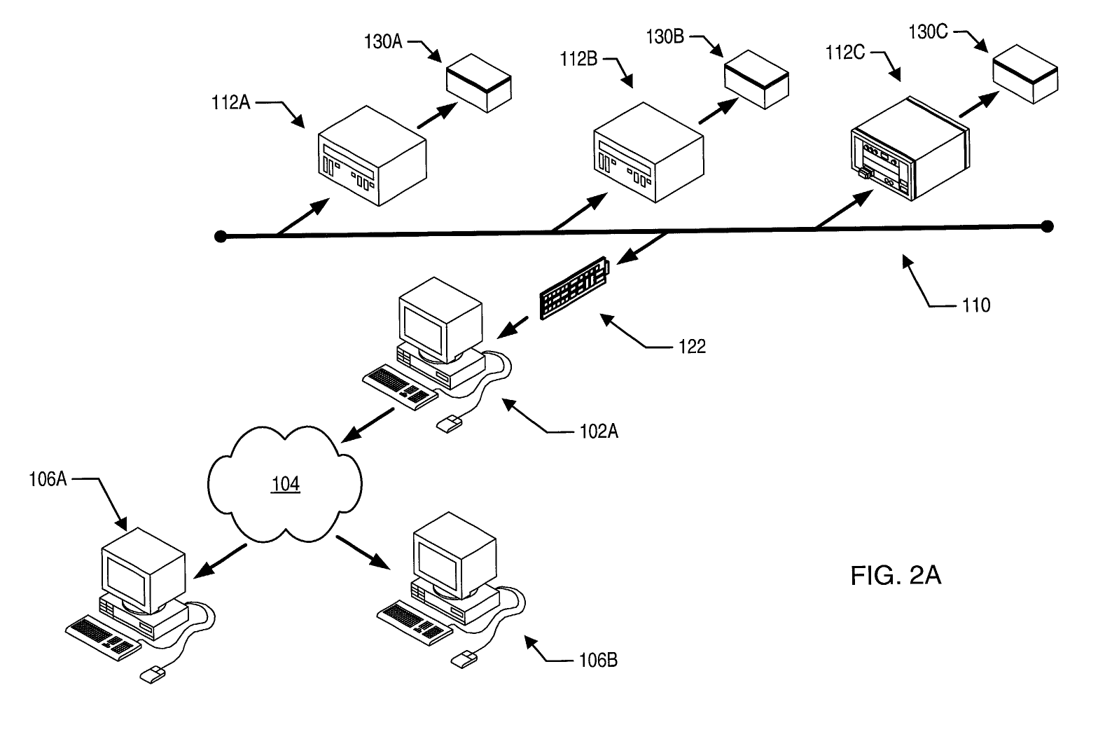

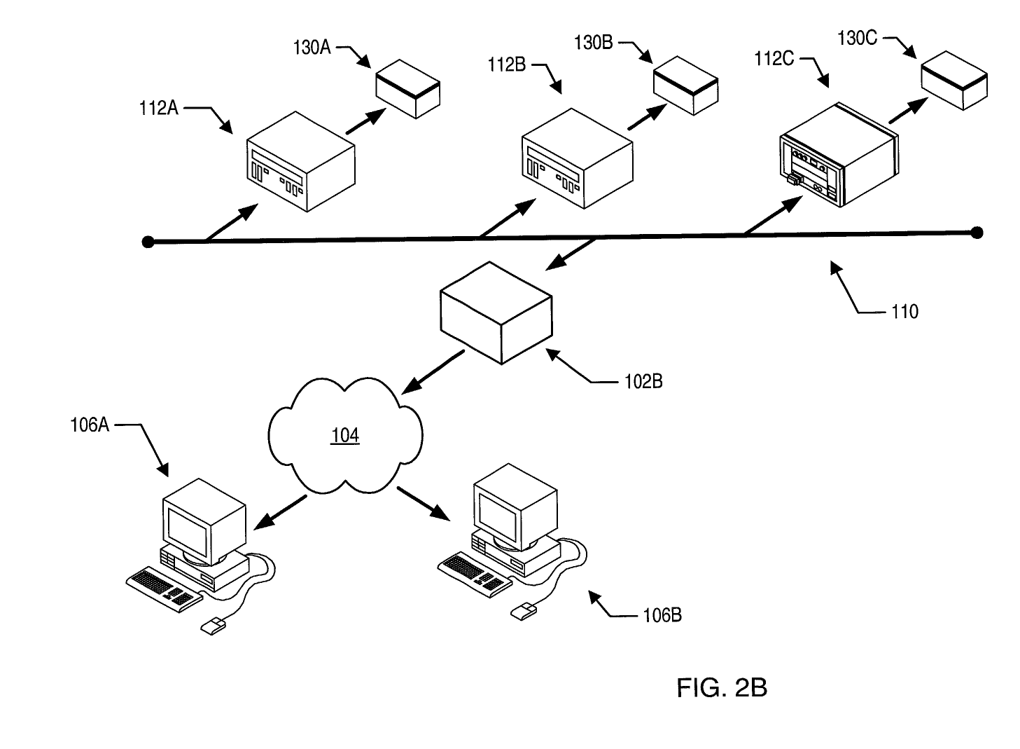

FIGS. 2A and 2B—Embodiments of an Instrument Server System

FIG. 2A illustrates an instrument server system according to one embodiment. The system comprises a server device 102A which connects to one or more instruments 112. In one embodiment, the server device 102A is a computer system and may comprise a CPU, a display screen, memory, one or more ports operable to couple the server device 102A to a network 104, and one or more input devices such as a mouse or keyboard, as shown. The server device 102A connects to one or more instruments 112 on instrumentation bus 110. One embodiment may include a plurality of instrumentation buses 110 for coupling instruments 112 to server device 102A. Examples of instrumentation buses include the GPIB (General Purpose Interface Bus) or IEEE 488 or 488.2 bus, the VXI bus, the PXI bus, or a serial bus such as RS-232, USB or IEEE 1394.

Each of the instruments 112 may be operable to couple to one or more units under test (UUT) or processes 130 to analyze, measure and/or control the unit under test (UUT) or process 130, or alternatively may be coupled to receive field signals, typically generated by transducers. The system depicted in FIG. 2A may be used in a data acquisition and control application, in a test and measurement application, a process control application, or a man-machine interface application, among others.

The instruments may be “traditional instruments” or “box instruments” such as oscilloscopes, multimeters, signal analyzers, frequency analyzers and other types of instrument or measurement devices. As used herein, the term “traditional instrument” refers to a traditional or box instrument that may be characterized by a chassis, typically having six sides, a physical front panel comprised on at least one side of the chassis, and vendor-defined instrument functionality contained within the chassis. The front panel or other parts of the chassis may include one or more physical controls such as knobs or switches for controlling various aspects of the instrument functionality. The front panel may also comprise one or more displays (e.g. CRT or LCD displays) for displaying instrument information and/or data either graphically or textually. Traditional instruments do not inherently have networking (e.g. Internet) capabilities. In other words, traditional instruments are not inherently capable of connecting to the Internet to display Web pages or to serve Web pages accessible from computer systems to display instrument data and/or control instrument functionality via the Internet. Hence, without use of the present invention, the user will not be able to access these instruments using the network (e.g. Internet). The term “instrument” is used herein to refer to traditional instruments and to instruments (both standalone instruments and instrument cards and boards that may be installed in computer systems) that are inherently capable of connecting to the Internet.

In one embodiment, the instruments 112 on instrumentation bus 110 may couple to the server device 102A via a bus interface card 122 provided by the server device 102A. The card 122 may be plugged in to an I/O slot in the server device 102A, such as a PCI bus slot, a PC Card slot, or an ISA, EISA or MicroChannel bus slot provided by the server device 102A. However, the interface card 122 is shown external to server device 102A for illustrative purposes. In one embodiment, the instruments 112 on instrumentation bus 110 may couple to the server device 102A via a bus interface integrated into the motherboard of the server device 102A. For example, a serial interface may be integrated into the motherboard of the device.

The server device 102A preferably includes a memory media, such as a magnetic media, random access memory or removable media such as CD-ROM or floppy disks. The memory media preferably stores driver level software for the instrumentation bus. For example, if instrumentation bus 110 is GPIB, the memory media may store GPIB driver level software, for example, the NI-488.2 software available from National Instruments Corporation. The present invention thus comprises driver level software for the instrumentation bus 110 stored on a memory and/or hard drive of the server device 102A and executed by a CPU of the server device 102A.

The memory media also may store an application program which interfaces through the driver level software to one or more instruments 112. The application program may be used for high-level control of the instrument(s) 112. The application program may operate in conjunction with one or more instrument drivers to interface through the instrumentation bus driver level software to the instruments 112. The application program may be created with various development platforms, such as the LabVIEW graphical programming language or the LabWindows\CVI interactive C development environment. These software development environments may include fully integrated libraries for instrumentation bus 110 and instrument 112 control. The application program may make calls to various functions in the driver level software to communicate with the instrumentation bus hardware and thus to the instruments 112.

The driver level software may interface the commands or function calls in the application programs to the actual instrumentation bus interface. In other words, in response to function calls made by the application, the instrumentation bus driver level software communicates with the instrumentation bus controller to control the instruments 112. The instrumentation bus driver level software thus handles the details of communication, i.e., the transfer of commands and data, over the instrumentation bus 110 connection between the computer and the instruments 112. As an example, the de facto standard for GPIB driver level software is the NI-488.2 software architecture available from National Instruments. The NI-488.2 software architecture includes an Application Programming Interface (API) which allows the GPIB application to call or invoke functions in the GPIB driver level software to communicate with the GPIB hardware.

The application program may also serve as an instrument server that may provide a network interface to the one or more instruments 112 on the instrumentation bus 110. Hereinafter, the application program is referred to as an instrument server. In one embodiment, the instrument server may communicate to an instrument 112 through an instrument driver associated with the instrument 112. Thus, the instrument driver may perform all direct communications to the instrument 112 over the instrumentation bus 110. In one embodiment, the instrument driver may provide an application programming interface (API) to the instrument server, and the instrument server may use the API to communicate with the instrument through the instrument driver 140.

The server device 102A operates to provide network server capabilities for the instruments 112. As shown, the server device 102A connects to a network 104 such as the Internet. The server device 102A may connect to the network 104 using one of several protocols such as Ethernet, low level protocols that support TCP/IP, or other types of protocols.

One or more other devices 106 may also be coupled to the network 104. A device 106 may comprise a CPU, a display screen, and one or more input devices such as a mouse or keyboard, as shown. The device 106 preferably includes a memory media, such as a magnetic media, CD-ROM, or floppy disk. The memory media preferably stores software for accessing the server device 102A over the network 104. For example, if the network 104 is the Internet, the memory media preferably stores a web browser such as those provided by Microsoft Corporation and Netscape Corporation. Hereinafter, devices 106 may be referred to as client systems.

A client system 106 which may be executing a web browser may access the instrument server executing within the server device 102A through the network 104 in order to monitor and/or control one or more of the respective instruments 112. Thus, the client web browser executing on the client system 106 may access the instrument server on server device 102A through the network 104. The instrument server may then in turn communicate with the actual instruments 112 through the instrumentation bus 110.

In one embodiment, when the client system 106 accesses the instrument server, the instrument server may provide to the client system 106 a user interface to the functionality of the instrument server. For example, a user interface to the instrument server may include a web page that may serve as the front end, or “home page”, to the instrument server. In one embodiment, when a client system 106 accesses the instrument server, the instrument server may provide information about the one or more instruments 112 currently available on instrumentation bus 110. In one embodiment, the instrument server may scan the instrumentation bus 110 (for example, by polling the bus addresses) to locate and, if possible, obtain information about detected instruments 112. This instrument information may then be provided to the client system 106. In one embodiment, the instrument information may be displayed in one or more web pages on the client system 106. The instrument information may include identity information (e.g. manufacturer and model number) for the instruments 112. For at least some of the instruments 112, the instrument information may also include other, more detailed information about the instrument. For example, the detailed information may indicate whether or not an instrument driver for the instrument 112 is stored on the client system 106.

The instrument information displayed on the client system 106 may then be used to select one or more instruments 112 to be monitored and/or controlled from client system 106. For example, each instrument 112 may have associated instrument information, and the instrument information may include or be associated with a web link, for example, a Universal Resource Locator (URL), that may, when selected access a web page or web pages associated with the particular instrument 112. To select the instrument 112, a user may select the web link. The web link may be displayed as text or alternatively as an icon or other image. One skilled in the art will recognize that any of various techniques may be used to select and/or activate one or more web pages.

When an instrument 112 is selected from client system 106, the instrument server on server device 102A may provide one or more web pages to client system 106 as a graphical user interface to the instrument 112. The one or more web pages may be displayed by the web browser on client system 106. The one or more web pages may provide a virtual instrument graphical user interface (GUI) to the associated instrument 112. This GUI may provide a virtual, “soft” front panel to the instrument 112 that allows the user to control and observe the instrument 112 in a manner similar to directly controlling the instrument 112's front panel. The virtual instrument GUI may herein be referred to as a “virtual front panel”, “soft front panel”, “instrument graphical user interface” or “instrument GUI”. A user of client system 106 may use the GUI provided by the one or more web pages to monitor and/or control the activities of the associated instrument 112.

In one embodiment, the one or more web pages of the instrument GUI of the instrument 112 (the “soft front panel”) are provided by the instrument driver for the instrument 112 to the client system 106. Alternatively, the instrument GUI may be provided by a separate program that uses the instrument driver to access the instrument. In this case, the instrument server may allow the separate program to be downloaded to the client system 106 for remotely controlling and monitoring the associated instrument 112 through the instrument GUI provided by the separate program. In either case, the instrument GUI may be displayed in a web browser on the client system 106. The instrument driver is then directed by input to the instrument GUI displayed on the client system 106 to control and/or monitor the instrument 112 via the network 104. The actual instrument control, monitoring (data acquisition) and any data manipulation (conversion, sampling, compression, etc), if necessary, may be performed by the instrument driver in response to input to the instrument GUI. In one embodiment, data that is to be displayed on the web pages of the instrument GUI on the client system 106 may be sent from the server device 102A to the client system 106 via the network.

FIG. 2B illustrates another embodiment of an instrument server system. The system comprises a server device 102B which connects to one or more instruments. In this embodiment, the server device 102B may be a dedicatd instrumentation server device that may comprise a processor, a memory, and one or more ports for coupling to network 104, but may not include a display device and user input devices as illustrated for server device 102A of FIG. 2A. Other than the differences in the server devices 102, however, the embodiment of an instrument server system as illustrated in FIG. 2B may function similarly or identically to the embodiment of an instrument server system as illustrated in FIG. 2A. Thus, the instrument server device 102B is not a general purpose device, but rather may be a device configured as a “box” whose sole purpose is to provide instrument server functionality to one or more traditional instruments coupled to the device 102B.

The server device 102B may include hardware and/or software to connect to one or more instruments 112 via one or more instrumentation buses 110. Each of the instruments 112 may be coupled to one or more units under test (UUT) or processes 130 to analyze, measure and/or control the unit under test (UUT) or process 130, or alternatively may be coupled to receive field signals, typically generated by transducers. The system depicted in FIG. 2B may be used in a data acquisition and control application, in a test and measurement application, a process control application, or a man-machine interface application, among others. The instruments may be instruments such as oscilloscopes, multimeters, signal analyzers, frequency analyzers and other types of instrument or measurement devices. These instruments may not inherently have network (e.g. Internet) capabilities. Hence, without use of the present invention, the user will not be able to access these instruments 112 using the network (e.g. Internet).

The server device 102B may comprise an instrument server that may provide a network interface to the one or more instruments 112 on the instrumentation bus 110. In one embodiment, the instrument server may communicate to an instrument 112 through an instrument driver associated with the instrument 112. Thus, the instrument driver may perform all direct communications to the instrument 112 over the instrumentation bus 110. In one embodiment, the instrument driver may provide an application programming interface (API) to the instrument server, and the instrument server may use the API to communicate with the instrument through the instrument driver 140.

The server device 102B operates to provide network server capabilities for the instruments 112. As shown, the server device 102B connects to a network 104 such as the Internet. The server device 102B may connect to the network 104 using one of several protocols such as Ethernet, low level protocols that support TCP/IP, or other types of protocols. One or more client systems 106 may also be coupled to the network 104. A client system 106 may comprise a CPU, a display screen, and one or more input devices such as a mouse or keyboard, as shown. The client system 106 preferably includes a memory media, such as a magnetic media, CD-ROM, or floppy disk. The memory media preferably stores software for accessing the server device 102B over the network 104. A client system 106 which may be executing a web browser may access the instrument server executing within the server device 102B through the network 104 in order to monitor and/or control one or more of the respective instruments 112. Thus, the client web browser executing on the client system 106 may access the instrument server on server device 102B through the network 104. The instrument server may then communicate with the actual instruments 112 through the instrumentation bus 110.

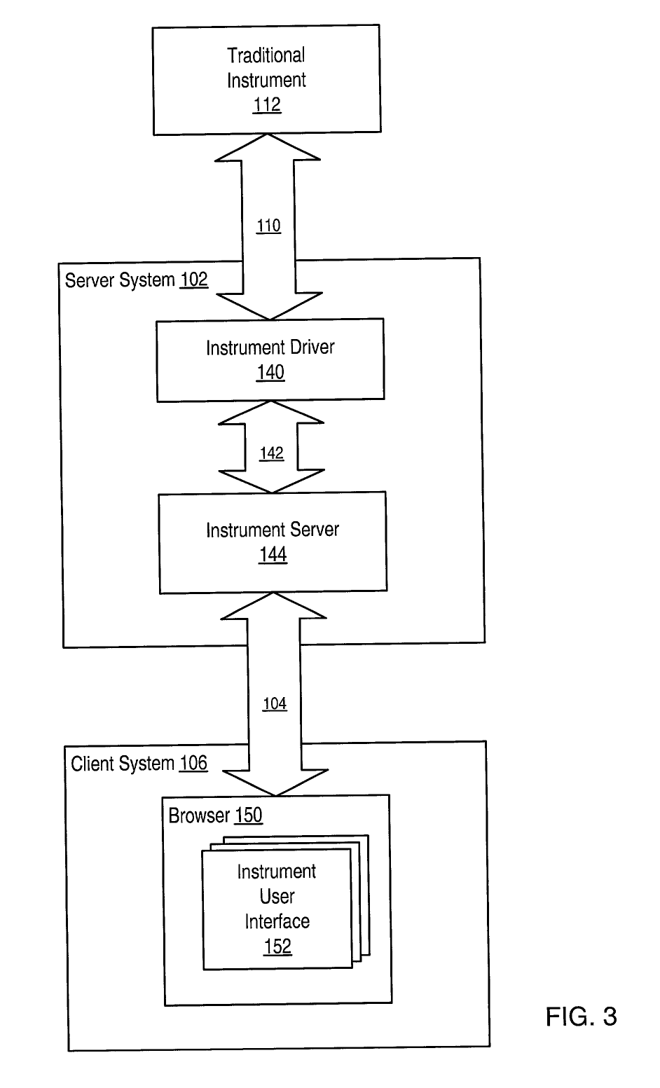

FIG. 3—Block Diagram of One Embodiment of an Instrument Server System

FIG. 3 is a block diagram illustrating one embodiment of an instrument server system. As shown, the system may include one or more instruments 112. These instruments may be traditional instruments such as oscilloscopes, multimeters, signal analyzers, frequency analyzers and other types of instrument or measurement devices. Traditional instruments do not inherently have Internet capabilities. Hence, without use of the present invention, the user will not be able to access traditional instruments using the Internet. As shown, these one or more instruments 112 may connect to an instrumentation bus 110. Examples of instrumentation buses include the GPIB (General Purpose Interface Bus) or IEEE 488 or 488.2 buses, the VXI bus, the PCI bus, or a serial bus such as RS-232, USB or IEEE 1394. Each instrument 112 may also be connected to one or more units under test (UUTs) 130 (not shown) to analyze, measure and/or control the UUTs.

A server system 102 may be executing an instrument server 144 that may connect to the one or more instruments 112 through the instrumentation bus 110. For example, the instrument server 144 may connect through a serial port to one or more instruments 112. As another example, the one or more instruments 112 may be coupled through a GPIB to the instrument server 102. In yet another example, an instrument 112 may comprise PXI card(s) in a PXI chassis, and the sever may connect to the instrument 112 through a PCI bus. In still yet another example, an instrument server 144 may connect to a VXI-compatible instrument 112 through a VXI bus or through another bus, such as the MXI bus. In one embodiment, an instrument server 144 may communicate to an instrument 112 through an instrument driver 140 associated with the instrument 112. The instrument driver 140 may perform all direct communications to the instrument 112 over instrumentation bus 110. In one embodiment, the instrument driver 140 may provide an application programming interface (API) 142 to the instrument server 144, and the instrument server 144 may use the API 142 to communicate with the instrument 112 through the instrument driver 140.

The instrument server 102 operates to provide Internet server capabilities for the respective instruments 112. As shown, the instrument server 102 may connect to a network 104 such as the Internet. A client system 106 which may be executing a client web browser 150 may access the instrument server 102 through the network 104 in order to monitor and/or control one or more of the respective instruments 112. The instrument server 102 may connect to the network 104 using any desired protocol such as Ethernet, low level protocols that support TCP/IP, or other types of protocols. Thus, the client web browser 150 executing on the client system 106 may access the instrument server 102 through the Internet 104. The instrument server 102 may then in turn communicate with the actual instruments 112 coupled to the instrumentation bus 110 through the instrument driver(s) 140.

The instrument server 144 may access an instrument 112 on instrumentation bus 110 using an instrument driver 140 for the instrument 112. In one embodiment, the instrument driver 140 may not previously exist on server system 102. In one embodiment, if an instrument driver 140 does not exist on server system 102 for a detected instrument 112, an instrument driver 140 for the instrument 112 may be downloaded from another system on the network 104. For example, the instrument driver 140 may be downloaded from a server that includes instrument drivers 140 for instruments 106 provided by a particular vendor on the network 104. In one embodiment, an instrument driver 140 for an instrument 112 may be downloaded (or alternatively uploaded) from a client system 106, for example, one that has selected a particular instrument 112.

In one embodiment, when the client system 106 accesses the instrument server, the instrument server may provide to the client system 106 a user interface to the functionality of the instrument server 144. In one embodiment, when a client system 106 accesses the instrument server 144, the instrument server 144 may provide information about the one or more instruments 112 currently available on instrumentation bus 110. In one embodiment, the instrument server 144 may scan the instrumentation bus 110 (for example, by polling the bus addresses) to locate and, if possible, obtain information about detected instruments 112. This instrument information may then be provided to the client system 106. In one embodiment, the instrument information may be displayed in one or more web pages on the client system 106. The instrument information may include identity information (e.g. manufacturer and model number) for the instruments 112. For at least some of the instruments 112, the instrument information may also include other information about the instrument. In one embodiment, the instrument server may serve a web page to the client system 106 that includes one or more icons, with each icon associated with one of the detected instruments 112. The user may then select one of the icons to display additional information about the associated instrument 112.

On some instrumentation buses 110, it may not be possible to automatically acquire instrument information for at least some instruments 112 connected to the instrumentation bus 110. As an example, on a GPIB, the instrument server 144 may be able to detect and identify the manufacturer and model number of one or more instruments 112 connected to the GPIB that support the IEEE 488.2 protocol. One or more other instruments 112 may be connected to the GPIB that the instrument server 144 can detect but not identify. In one embodiment, for instruments 112 that can be detected but not identified, the instrument server 144 may provide a mechanism that allows a user of the server system 102 to identify the detected instruments. In one embodiment, the instrument server 144 may provide a mechanism to allow a user of a client system 106 to identify detected instruments. For example, a web page provided to the client system 106 by the instrument server 144 may provide one or more fields for the user to enter additional information about one or more detected instruments 112.

The instrument information displayed on the client system 106 may then be used to select one or more instruments 112 to be monitored and/or controlled from client system 106. For example, the instrument information for an instrument 112 may include a web link, for example, a Universal Resource Locator (URL), that the user may select to access a web page or web pages associated with the particular instrument 112. The web pages are preferably provided by the instrument server 144. To select the instrument 112, a user may select the web link associated with the instrument 112.

When an instrument 112 is selected from client system 106, the instrument server 144 on server device 102 may provide to the client system 106 one or more web pages as a user interface 152 to the particular instrument 112. The one or more web pages may be displayed by the web browser 150 on client system 106. The one or more web pages may provide a virtual instrument graphical user interface to the associated instrument 112. A user of client system 106 may use the instrument user interface 152 provided by the one or more web pages to monitor and/or control the activities of the associated instrument 112.

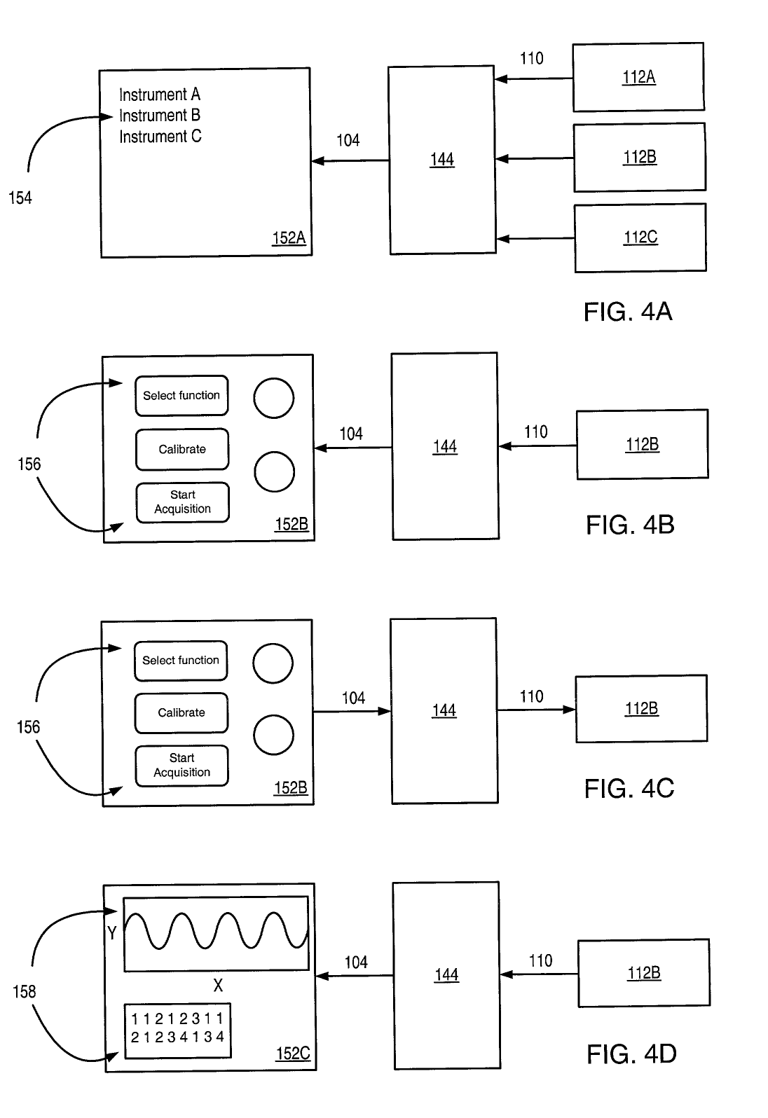

FIGS. 4A-4B—Example of Using One Embodiment of an Instrument Server System

FIGS. 4A through 4D illustrate an example of using an instrument server 144 to monitor and control the activities of one or more instruments 112 according to one embodiment. In FIG. 4A, instrument server 144 has located three instruments 112 on an instrumentation bus 110. The instrument server 144 may get identification information from each of the three instruments 112. A client system 106 may connect to instrument server 144. Instrument server 144 may provide a web page 152A that includes the identification information 154 for the instruments 112, which may be displayed on a web browser on client system 106. A user of client system 106 may then select one of the three instruments 112, in this example instrument 112B.

As illustrated in FIG. 4B, when the instrument 112B is selected, the instrument server 144 may provide a web page 152B to client system 106 which may be displayed by the web browser on the client system 106. Web page 152B may include one or more control items 156 for controlling various functionality of instrument 112B. Control items 156 may include, but are not limited to, buttons, menus, switches, dials, slides, text and numeric entry fields, and others. One skilled in the art will recognize that there are a variety of other kinds of control items that may be utilized. The user may then manipulate one or more of the control items 156 to configure, calibrate, start or otherwise control instrument 112B over network 104 through instrument server 144.

As illustrated in FIG. 4C, one or more of the control items may be manipulated by the user of client system 106 to initiate, through instrument server 144, one or more monitoring functions of instrument 112B. As illustrated in FIG. 4D, when a monitoring function is initiated, the instrument server 144 may provide a web page 152C to client system 106 which may be displayed by the web browser on the client system 106. Web page 152C may include one or more display items 158 for displaying data output of instrument 112B, and thus may allow the user to monitor the operation of instrument 112B through the instrument server 144. Instrument 112B may send data through instrumentation bus 110 to instrument server 144, which may then send the data to client system 106. The data may then be displayed in the relevant display item(s) 158 on web page 152C. There are a variety of types display items in which the data may be displayed, including, but not limited to: graphs, charts, alphanumeric fields, ON/OFF switches, indicator lights, bars, gauges, dials, etc. One skilled in the art will recognize that there are a variety of other kinds of display items that may be utilized to display data graphically and/or textually.

Note that control items 156 and display items 158 may be combined on a web page 152. Thus, when a user selects a control item to begin monitoring one or more functions of the instrument 112B, it may not be necessary to download a separate web page 152C to display the data. Instead, the data may be displayed in one or more display items 158 on the web page 152B. In one embodiment, the user of the client system 106 may select one or more other instruments 112, and thus control and/or monitor two or more instruments 112 simultaneously through the network interface provided by the instrument server 144.

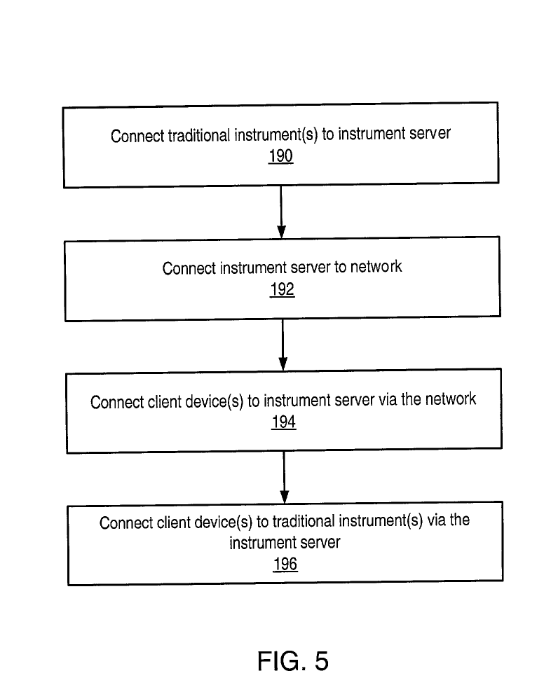

FIG. 5—Connecting Traditional Instruments Via an Instrument Server

FIG. 5 is a flowchart illustrating a method of connecting traditional instruments to client systems on a network via an instrument server according to one embodiment. As indicated at 190, one or more traditional instruments 112 may be connected to an instrument server 144. Connecting a traditional instrument 112 may include physically coupling the traditional instrument 112 to the instrumentation bus 110 of the server device 102 that includes the instrument server 144 software. For example, a GPIB instrument is connected to a GPIB bus cable, and the GPIB cable is then connected to a GPIB port on the server device 102. Connecting the traditional instrument 112 may also include installing instrument driver and/or other software for enabling the server device 102 to communicate to the traditional instrument.

As indicated at 192, the instrument server 144 may then be connected to the network 104, if not already connected. Connecting the instrument server 144 to the network may include physically connecting the server device to the network 104 by plugging a network cable into a network-capable port on the server device 102 that includes the instrument server 144. For a wireless connection to a network, the instrument server 144 may be wirelessly coupled to the network 104.

Once the physical connections are established that connect the traditional instrument(s) 112 to the server device 102 and the server device 102 to the network 104, the server device 102 and the traditional instrument(s) may be powered on, if necessary. Various software components, including the instrument server 144 software, may then be started, if necessary. Starting the instrument server 144 software may include the instrument server 144 establishing a network presence as a server that hosts one or more Web pages. In one embodiment, starting the instrument server 144 software may also include the instrument server 144 scanning one or more connected instrumentation busses 110 to detect currently connected traditional instruments 112.

Once 190 and 192 are complete, the instrument server 144 is accessible on the network 104 to client systems 106. As indicated at 194, a client system 106 may then establish a connection to the instrument server 144 on the network. In one embodiment, a user of the client system 106 may access the instrument server 144 through a Web browser on the client system 106. For example, in one embodiment the user may enter a Universal Resource Locator (URL) to a “home” Web page of the site hosted by the instrument server 144. Alternatively, the user may select a URL displayed on the Web browser textually or as an icon to access the Web page of the instrument server 144. One skilled in the art will recognize that there are other methods that may be used to select or activate a Web page from a client system 106. As indicated at 196, the user may then access one or more traditional instruments 112 connected to the instrument server 144 through interfaces to the instruments 112 displayed in web page(s) served by the instrument server 144 and displayed in the web browser on the client device. Through an interface to a traditional instrument 112 displayed in the web browser, the user may send control instructions to the instrument 112. Instrumentation data received from the traditional instrument 112 may be displayed in the interface on the web browser. Thus, the instrument server 144 provides a network presence to traditional instruments 112 that otherwise do not have a network presence, including the ability to remotely control the instruments 112 over the network, and to receive and display instrumentation data from the instruments 112.

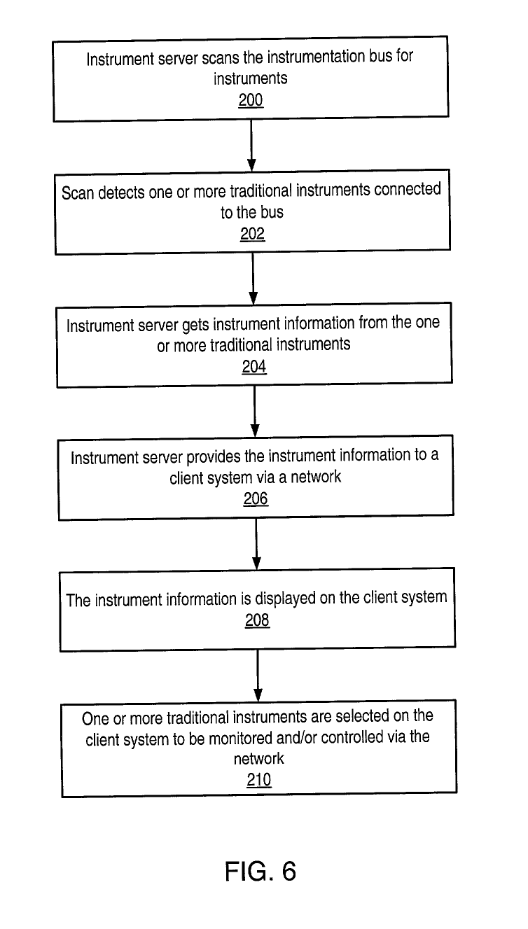

FIG. 6—An Instrument Server Providing Information about Instruments

FIG. 6 is a flowchart illustrating a method of an instrument server getting a list of instruments and providing information about the instruments to a client system according to one embodiment. As indicated at 200, an instrument server 144 may scan the instrumentation bus 110 for instruments. As indicated at 202, the scanning of the instrumentation bus may detect one or more traditional instruments 112 connected to the instrumentation bus 110. The instrument server 144 may then request and receive instrument information from the one or more detected traditional instruments 112 as indicated at 204. The instrument information may include identification information (e.g. manufacturer, model number, version). Some traditional instruments 112 may not provide identification information and/or other instrument information to the instrument server 144.

The instrument server 144 may provide the instrument information to a client system 106 via a network 104 as indicated at 206. In one embodiment, the client system 106 may access the instrument server 112 through a web page hosted by the instrument server 144. In one embodiment, the web page may automatically provide the list of instruments 112 and their related information when the web page is opened on the client system 106. In another embodiment, the web page may include a method for the list of instruments 112 to be requested on the client system. For example, the web page may include a link (e.g. URL) to a second web page that displays the list of instruments 112. The instrument information may then be displayed on the client system 106 as indicated at 208. For example, the instrument information may be displayed on a web page provided by the instrument server 144. In one embodiment, a user may be able to identify and/or provide other information for instruments 112 that do not provide the information to the instrument server by entering the information in a web page interface provided by the instrumentation server 144 and displayed on the client device 106.

As indicated at 210, one or more instruments 112 may then be selected on the client system 106 to allow the instruments 112 to be monitored and/or controlled via the network from the client system 106. In one embodiment, the web page displaying the list of instruments 112 and their related information may include a link (e.g. URL) for each instrument 112 that accesses yet another web page or web pages that act as a virtual “front panel” graphical user interface to the selected instrument 112. From these web pages for the particular instrument 112, the instrument may be controlled from, and instrument data generated by the instrument may be displayed on, the client system 106 via the network connection to the instrument server 144.

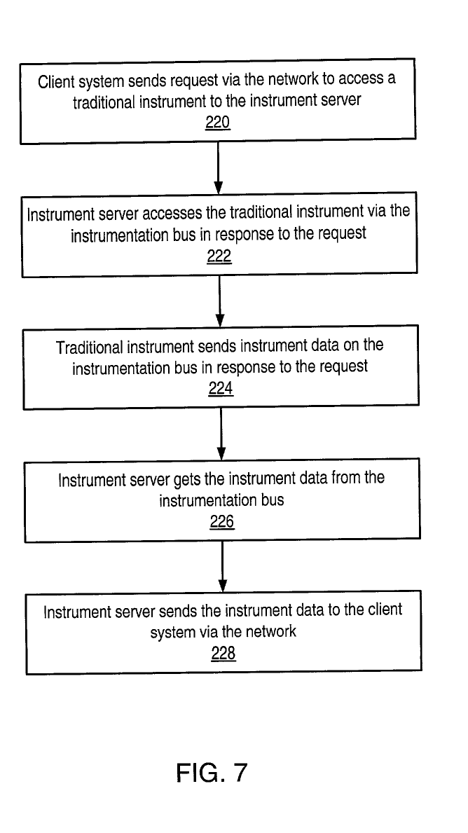

FIG. 7—Using an Instrument Server to Access Instrument Data over a Network

FIG. 7 is a flowchart illustrating a method of using an instrument server to access instrument data over a network according to one embodiment. As indicated at 220, a client system 106 may send a request via the network 104 to access an instrument 112 to the instrument server 144. In one embodiment, the client system 106 may send the request in one or more packets on the network 104. In one embodiment, the network 104 is the Internet, and the one or more packets are IP packets. The instrument server 144 then may access the instrument via the instrumentation bus 110 in response to the request as indicated at 222. At 224, the instrument 112 may send instrument data on the instrumentation bus 110 in response to the request. The instrument server 144 then may access the instrument data from the instrumentation bus 110 as indicated at 226. The instrument server 144 then may send a portion or all of the instrument data to the client system 106 via the network 104 as indicated at 228.

In one embodiment, the instrument server 144 interfaces with an instrument driver 140 associated with the instrument 112 to direct the action of the instrument 112. The instrument drive 140 then controls the actions of the instrument 112 in accordance with the request from the client system 106. In one embodiment, the instrument driver 140 controls the actions of the instrument 112 through a driver for the instrumentation bus 110. In one embodiment, the instrument 112 may return the data over the instrumentation bus 110. The instrument server may then access the instrument data through the instrument driver 140 of the instrument 112. In one embodiment, the instrument driver 140 accesses the instrumentation bus 110 through the instrumentation bus 110 driver.

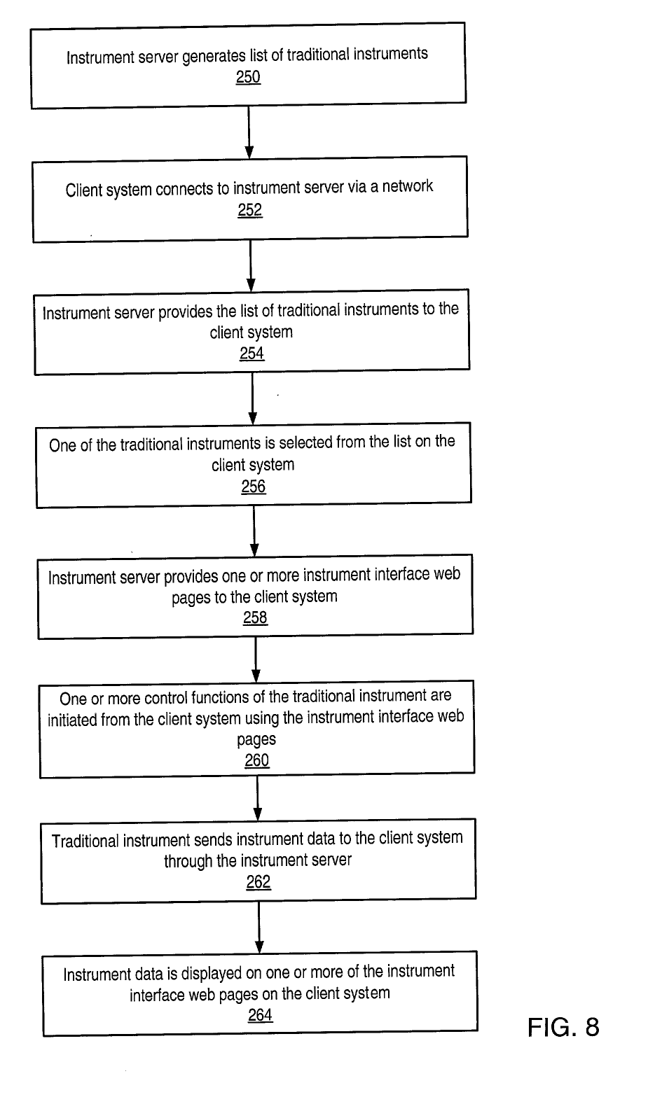

FIG. 8—Controlling and Monitoring Instruments over the Network

FIG. 8 is a flowchart illustrating a method of controlling and monitoring instruments over the network using an instrument server according to one embodiment. As indicated at 250, the instrument server 144 may generate a list of instruments. In one embodiment, in generating the list, the instrument server 144 may poll the instrument bus 110 to detect instruments 112 currently connected to the instrumentation bus 110. At 252, a client system 106 may connect to the instrument server 144 via a network 104. In one embodiment, the network 104 is the Internet. In this embodiment, the client system 106 may include a web browser 150, and the instrument server 144 may be a web server. The instrument server 144 may in this embodiment be accessed from the web browser 150 on client system 106 by selecting a link (e.g. URL) to the instrument server 144.

After the client system 106 has connected to the instrument server 144, the instrument server 144 may provide the list of instruments 112 to the client system 106 as indicated at 254. One or more of the instruments 112 may then be selected from the list on the client system 106 as indicated at 256. Selecting an instrument 112 from the client system 106 may cause the instrument server 144 to provide an instrument GUI to the client system 106 as indicated at 258. In one embodiment, the instrument GUI may comprise one or more web pages that may be displayed by the web browser on the client system 106. In one embodiment, the instrument GUI provides a virtual “front panel” to the instrument 112 that allows the instrument 112 to be controlled and/or monitored from the client system 106 via the network 104.

One or more control functions of the instrument 112 may be initiated from the client system 106 using the instrument GUI provided by the instrument server 144 as indicated at 260. In one embodiment, the instrument GUI may graphically display one or more instrument controls that allow the instrument 112 to be configured, calibrated, and to start data acquisition by the instrument 112. The instrument controls may be graphical controls and/or alphanumeric controls. For example, a web page may include a text entry box that allows text commands to be entered and sent to the instrument 112. As another example, a web page may include one or more graphical controls (e.g. dials, switches, sliding bars, etc.) that may be manipulated in the web page which generate control messages that are then sent to the instrument 112.

The instrument 112 may acquire data from one or more units under test (UUTs) 130. Note that data acquisition by the instrument 112 may include, but is not limited to, the acquisition of discrete values (i.e. readings), the acquisition of series of discrete values, and the acquisition of continuous data (e.g. an analog signal). The analog signal may be converted to digital data on the instrument 112 prior to providing the data to the server device 102. Alternatively, the analog signal may be provided to the server device 102 and converted to digital data on the server device 102.

As indicated at 262, the instrument 112 may send a portion or all of the acquired instrument data to the client system 106 through the instrument server 144. The instrument 112 may send the instrument data on the instrumentation bus 110. The instrument server 144 then may access the instrument data from the instrumentation bus 110. The instrument server 144 then may send a portion or all of the instrument data to the client system 106 via the network 104.

When the client system 106 receives the instrument data, a portion or all of the instrument data may be displayed on the instrument GUI on the client system 106 as indicated at 264. In one embodiment, the instrument GUI may include one or more web pages displayed by the web browser on the client system 106, and may alphanumerically and/or graphically display the data in the one or more web pages. The one or more web pages may each include one or more display items for displaying portions or all of the data graphically and/or alphanumerically. For example, a web page may include one or more alphanumeric display items to display the values of one or more discrete data elements. As another example, a web page main include a display item to graphically display a digitized, continuous analog signal (for example, a voltage) being acquired by the instrument 112.

In one embodiment, the controls provided by the instrument GUI to the instrument 112 on the client system 106 may be manipulated to modify the display of the instrument data being acquired and displayed on the client system 106. The controls may also be used to stop the acquisition of the instrument data, and/or to start acquisition and/or display of other instrument data.

In one embodiment, two or more instruments 112 may be controlled and/or monitored over the network via a client system 106 through the instrument server 144 simultaneously. Alternatively, a client system 106 may control instruments 112 coupled to two or more different instrument servers 144 simultaneously.

The methods as described in FIGS. 5 through 8 may be implemented in software, hardware, or a combination thereof. The order of method may be changed, and various steps may be added, reordered, combined, omitted, modified, etc. For example, the actions indicated at 252 of FIG. 8 may occur after the actions indicated at 250 of FIG. 8.

Various embodiments may further include receiving, sending or storing instructions and/or data implemented in accordance with the foregoing description upon a carrier medium. Generally speaking, a carrier medium may include storage media or memory media such as magnetic or optical media, e.g., disk or CD-ROM, volatile or nonvolatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

In summary, a system and method for providing web server capabilities for existing instruments without inherent networking capabilities have been disclosed. It will be appreciated by those of ordinary skill having the benefit of this disclosure that the illustrative embodiments described above are capable of numerous variations without departing from the scope and spirit of the invention. Various modifications and changes may be made as would be obvious to a person skilled in the art having the benefit of this disclosure. It is intended that the following claims be interpreted to embrace all such modifications and changes and, accordingly, the specifications and drawings are to be regarded in an illustrative rather than a restrictive sense.

We claim:

1. A method comprising:
a first device coupled to a network sending a request to a second device coupled to the network to access a traditional instrument, wherein the traditional instrument is coupled to the second device via an instrumentation bus, wherein the traditional instrument does not include inherent Internet capabilities, and wherein the second device comprises an instrument server;
the instrument server receiving the request to access the traditional instrument;
the instrument server accessing the traditional instrument via the instrumentation bus in response to said request to access the traditional instrument;
the traditional instrument sending instrument data to the server device via the instrumentation bus in response to the instrument server accessing the traditional instrument;
the instrument server receiving the instrument data sent from the traditional instrument via the instrumentation bus; and
the instrument server sending the instrument data to the first device via the network.

2. The method of claim 1, further comprising, prior to said first device sending the request to the second device, connecting the traditional instrument to the second device.

3. The method of claim 1, further comprising displaying on the first device a graphical user interface to the traditional instrument coupled to the second device, wherein the graphical user interface is operable by the user to remotely control functionality of the traditional instrument from the second device.

4. The method of claim 1, further comprising:
the first device receiving the instrument data from the instrument server via the network; and
displaying the received instrument data on the first device

5. The method of claim 4, wherein the first device comprises a web browser, wherein said displaying the instrument data on the first device is performed by the web browser, wherein the instrument data is displayed by the web browser in one or more web pages provided by the instrument server.

6. The method of claim 1, wherein the request to access the traditional instrument is generated in response to user input on the first device.

7. The method of claim 1, wherein the first device comprises a web browser, wherein the request to access the traditional instrument is generated in response to user input to the web browser program.

8. The method of claim 7, wherein the user input that generates the request to access the traditional instrument is received by the web browser in a web page provided by the instrument server.

9. The method of claim 8, wherein the web page provides a graphical user interface to the traditional instrument coupled to the second device.

10. The method of claim 1, wherein the instrument server accessing the traditional instrument comprises:
the instrument server accessing an instrument driver for the traditional instrument; and
the instrument driver accessing the first instrument via the instrumentation bus in response to the instrument server accessing the instrument driver.

11. The method of claim 10, wherein, prior to the instrument server accessing the instrument driver, the method further comprises the second device receiving the instrument driver from the first device.

12. The method of claim 10, wherein, prior to the instrument server accessing the instrument driver, the method further comprises downloading the first instrument driver from a third device to the second device via the network.

13. The method of claim 1, wherein the instrument server accessing the traditional instrument comprises the instrument server requesting the instrument data from the traditional instrument.

14. The method of claim 1, wherein the request to access the traditional instrument includes information requesting the traditional instrument to perform one or more actions, and wherein the instrument data is generated from the traditional instrument performing at least part of the requested one or more actions.

15. The method of claim 1, further comprising, prior to the first device sending the request to access the traditional instrument:
the instrument server providing instrument information about one or more traditional instruments coupled to the second device to the first device through the network, wherein the one or more traditional instruments include the traditional instrument; and
displaying the instrument information about the one or more traditional instruments on the first device.

16. The method of claim 15, further comprising:
receiving user input on the first device selecting the traditional instrument from the displayed instrument information about the one or more traditional instruments prior to the first device sending the request to access the traditional instrument.

17. The method of claim 15, wherein the first device comprises a web browser, wherein said displaying the instrument information about the one or more traditional instruments on the first device is performed by the web browser.

18. The method of claim 1, wherein a plurality of traditional instruments including the traditional instrument are coupled to the second device via the instrumentation bus, and wherein the first device is operable to send requests to access each of the plurality of traditional instruments to the second device.

19. The method of claim 1, further comprising:
the instrument server scanning the instrumentation bus to detect instruments coupled to the instrumentation bus;
said scanning detecting one or more traditional instruments coupled to the instrumentation bus including the traditional instrument; and
the instrument server receiving instrument information from each of the detected one or more traditional instruments; and
the instrument server providing the instrument information from the one or more detected traditional instruments to the first device;
wherein the one or more traditional instruments are user-selectable from the first device using the instrument information.

20. The method of claim 1, wherein there are one or more other devices coupled to the network, and wherein the second device is operable to receive requests to access the traditional instrument from the one or more other devices.

21. The method of claim 1, wherein the instrumentation bus is one of a GPIB instrumentation bus, a PCI instrumentation bus, a PXI instrumentation bus, and a serial instrumentation bus.

22. The method of claim 1, wherein the network is the Internet.

23. A method comprising:
scanning an instrumentation bus coupled to a first device to detect instruments coupled to the instrumentation bus;
said scanning detecting a first traditional instrument coupled to the instrumentation bus, wherein the first traditional instrument does not include inherent Internet capabilities;
receiving instrument information from the detected first traditional instrument;
providing the instrument information of the first traditional instrument to a second device coupled to the first device via a network; and
displaying the instrument information of the first traditional instrument on the second device;
wherein the first traditional instrument coupled to the first device via the instrumentation bus is remotely accessible from the second device to initiate monitor and control functions of the first traditional instrument.

24. The method of claim 23, wherein the second device comprises a web browser program, wherein said displaying the instrument information comprises the web browser program displaying the instrument information in a web page.

25. The method of claim 23, further comprising:
receiving user input on the second device, wherein the user input specifies the first traditional instrument; and
sending a request to access the first traditional instrument from the second device to the first device through the network in response to the user input.

26. The method of claim 25, further comprising:
the first device sending a user interface specification for the first traditional instrument to the second device via the network in response to the request to access the first traditional instrument; and
displaying on the second device a user interface to the first traditional instrument in accordance with the user interface specification.

27. The method of claim 26, wherein the user interface specification includes one or more web pages displayable by a web browser on the second device.

28. The method of claim 23, wherein said scanning detects a plurality of traditional instruments including the first traditional instrument coupled to the first device via the instrumentation bus, and wherein said receiving the instrument information, said providing the instrument information, and said displaying the instrument information are performed for the plurality of traditional instruments.

29. The method of claim 23, wherein there are one or more other devices coupled to the network, wherein the method further comprises providing the instrument information of the first traditional instrument to the one or more other devices, and wherein the first traditional instrument coupled to the first device via the instrumentation bus is remotely accessible from the one or more other devices to initiate monitor and control functions of the first traditional instrument.

30. The method of claim 23, wherein said scanning, said receiving, and said providing are performed by an instrument server executable on the first device.

31. The method of claim 23, wherein, after said detecting the first traditional instrument, the method further comprises downloading an instrument driver for the first traditional instrument from another device to the first device via the network.

32. The method of claim 23, wherein the network is the Internet.

33. A method for providing Internet capabilities to a traditional instrument, wherein the traditional instrument does not inherently include Internet capabilities, the method comprising:
connecting the traditional instrument to a first device, wherein the first device includes an Internet server; and
connecting the first device to the Internet;
wherein the Internet server provides web pages accessible from other devices connected to the Internet, wherein the web pages include one or more web pages configured for use in accessing the traditional instrument connected to the first device.

34. The method of claim 33, wherein said accessing the traditional instrument includes sending command instructions to the traditional instrument and receiving and displaying instrumentation data from the traditional instrument.

35. The method of claim 33, further comprising:
accessing the Internet server from a second device connected to the Internet; and
displaying one or more of the web pages provided by the Internet server in a web browser on the second device;
wherein the displayed one or more web pages include information configured for use in accessing the traditional instrument from the second device.

36. The method as recited in claim 33, further comprising:
accessing the Internet server from a second device connected to the Internet; and
displaying in a web browser on the second device at least one of the one or more web pages configured for use in accessing the traditional instrument connected to the first device.

37. The method as recited in claim 33, wherein the one or more web pages configured for use in accessing the traditional instrument connected to the first device each include interface items for the traditional instrument, wherein the interface items of a particular web page include one or more of control items and display items;
wherein the control items are user-selectable to send control instructions to the traditional instrument; and
wherein the display items are configured for use in displaying data received from the traditional instrument.

38. A device comprising:
a first port operable to couple to a network;
a second port operable to couple to an instrumentation bus;
a processor; and
memory operable to store program instructions, wherein the program instructions are executable by the processor to:
receive from another device coupled to the network a request to access a traditional instrument coupled to the instrumentation bus, wherein the traditional instrument does not include inherent Internet capabilities;
access the traditional instrument via the instrumentation bus in response to said request to access the traditional instrument;
receive instrument data sent from the traditional instrument via the second port; and
send the instrument data to the other device via the first port.

39. The device of claim 38, wherein the program instructions are further executable by the processor to provide to the other device a graphical user interface for the traditional instrument, wherein the graphical user interface is executable within the other device to initiate monitor and control functions of the traditional instrument from the other device and to display the received instrument data.

40. The device of claim 39, wherein the graphical user interface comprises one or more web pages displayable by a web browser on the other device.

41. The device of claim 38, wherein the device further comprises an instrument driver for the traditional instrument, wherein, in said accessing the traditional instrument via the instrumentation bus, the program instructions are further executable by the processor to:
access the instrument driver for the traditional instrument; and
wherein the instrument driver is executable by the processor to access the traditional instrument via the instrumentation bus in response to said accessing the instrument driver; and
wherein, in said receiving the instrument data sent from the traditional instrument via the second port, the program instructions are further executable by the processor to receive the instrument data from the instrument driver.

42. The device of claim 38, wherein, in said accessing the traditional instrument via the instrumentation bus, the program instructions are further executable by the processor to request the instrument data from the traditional instrument.

43. The device of claim 38, wherein the instrumentation bus is one of a GPIB instrumentation bus, a PCI instrumentation bus, a PXI instrumentation bus, and a serial instrumentation bus.

44. The device of claim 38, wherein the network is the Internet.

45. A device comprising:
a first port operable to couple to a network;
a second port operable to couple to an instrumentation bus;
a processor; and memory operable to store program instructions, wherein the program instructions are executable by the processor to:
scan the instrumentation bus coupled to the second port to detect a traditional instrument coupled to the instrumentation bus, wherein the traditional instrument does not include inherent Internet capabilities;
receive instrument information from the detected traditional instrument via the second port; and
send the instrument information of the traditional instrument to another device coupled to the network;
wherein the traditional instrument coupled to the device via the instrumentation bus is remotely accessible from the other device to initiate monitor and control functions of the traditional instrument.

46. The device of claim 45, wherein the program instructions are further executable by the processor to provide to the other device a graphical user interface for the traditional instrument, wherein the graphical user interface is executable within the other device to display the received instrument information.

47. The device of claim 46, wherein the graphical user interface comprises one or more web pages displayable by a web browser on the other device.

48. The device of claim 45, wherein said scanning detects a plurality of traditional instruments including the traditional instrument coupled to the device via the instrumentation bus, and wherein the program instructions are further executable by the processor to:
receive instrument information from each of the detected plurality of traditional instruments via the second port; and
send the instrument information of the plurality of traditional instruments to the other device via the network.

49. The device of claim 45, wherein, after said detecting the traditional instrument, the program instructions are further executable by the processor to download an instrument driver for the traditional instrument from the other device to the device via the network.

50. The device of claim 45, wherein the instrumentation bus is one of a GPIB instrumentation bus, a PCI instrumentation bus, a PXI instrumentation bus, and a serial instrumentation bus.

51. The device of claim 45, wherein the network is the Internet.

52. A device comprising:
a first port operable to couple to a network;
a processor; and
memory operable to store program instructions, wherein the program instructions are executable by the processor to:
receive instrument information from another device coupled to the network, wherein the instrument information describes one or more traditional instruments coupled to the other device via an instrumentation bus, wherein the one or more traditional instruments do not include inherent Internet capabilities;
display the instrument information on the second device;
receive user input selecting a first traditional instrument of the one or more traditional instruments from the displayed instrument information; and
receive user input specifying one or more instructions to be sent to the other device via the network;
wherein the one or more instructions sent to the other device are configured to monitor and control the first traditional instrument from the device.

53. The device of claim 52, wherein the program instructions comprise a web browser, and wherein said receiving the instrument information, said displaying the instrument information, said receiving user input selecting the first traditional instrument, and said receiving user input specifying the one or more instructions are performed in one or more web pages displayed by the web browser.

54. The device of claim 52, wherein the program instructions are further executable within the device to:
receive instrument data sent from the other device; and
display the received instrument data;
wherein the instrument data is generated by the first traditional instrument on the other device in response to the one or more instructions.

55. The system of claim 54, wherein the program instructions comprise a web browser, and wherein the web browser is executable within the device to display the received instrument data on one or more web pages.

56. A system comprising:
a first device operable to couple to a network and to an instrumentation bus;
a second device operable to couple to the network;
one or more traditional instruments operable to couple to the instrumentation bus, wherein the one or more traditional instruments do not include inherent Internet capabilities;
first program instructions executable within the first device to:
detect the one or more traditional instruments coupled to the instrumentation bus; and
provide instrument information of the one or more traditional instruments to the second device via the network;
second program instructions executable within the second device to:
display the instrument information on the second device;
select a first traditional instrument of the one or more traditional instruments from the displayed instrument information; and
send requests to the first device via the network to monitor and control the first traditional instrument from the second device.

57. The system of claim 56, wherein the first program instructions are further executable within the first device to:
receive the requests sent by the second program instructions executing within the second device;
direct the first traditional instrument to perform the received requests;
receive instrument data generated by the first traditional instrument performing one or more of the received requests; and
send the received instrument data to the second device via the network.

58. The system of claim 56, further comprising an instrument driver for the first traditional instrument;
wherein, in said directing the first traditional instrument to perform the received requests, the first program instructions are further executable within the first device to direct the instrument driver to perform the received requests;
wherein the instrument driver is executable within the first device to:
direct the first traditional instrument to perform the received requests via the instrumentation bus; and
receive the instrument data from the first traditional instrument via the instrumentation bus;
wherein, in said receiving the instrument data generated by the first traditional instrument, the first program instructions are further executable within the first device to receive the instrument data from the instrument driver.

59. The system of claim 58, wherein the first program instructions are operable to download the instrument driver from the second device after the second program instructions perform said selecting the first traditional instrument.

60. The system of claim 58, wherein the second program instructions are further executable within the second device to:
receive the instrument data sent from the first device; and
display the received instrument data on the second device.

61. The system of claim 60, wherein the second program instructions comprise a web browser, and wherein the web browser is executable within the second device to display the received instrument data on one or more web pages, and wherein the first program instructions are operable to provide the one or more web pages to the web browser in response to said selecting the first traditional instrument.

62. The system of claim 56, wherein the second program instructions are further executable within the second device to receive user input specifying the requests to be sent to the first device.

63. The system of claim 62, wherein the second program instructions comprise a web browser, and wherein the web browser is executable within the second device to receive the user input specifying the requests in one or more web pages, and wherein the first program instructions are operable to provide the one or more web pages to the web browser in response to said selecting the first traditional instrument.

64. The system of claim 56, wherein the network is the Internet.

65. A carrier medium comprising program instructions, wherein the program instructions are computer-executable to implement:
a first device coupled to a network sending a request to a second device coupled to the network to access a traditional instrument, wherein the traditional instrument is coupled to the second device via an instrumentation bus, wherein the traditional instrument does not include inherent Internet capabilities, and wherein the second device comprises an instrument server;
the instrument server receiving the request to access the traditional instrument;
the instrument server accessing the traditional instrument via the instrumentation bus in response to said request to access the traditional instrument;
the traditional instrument sending instrument data to the server device via the instrumentation bus in response to the instrument server accessing the traditional instrument;
the instrument server receiving the instrument data sent from the traditional instrument via the instrumentation bus; and
the instrument server sending the instrument data to the first device via the network.

66. The carrier medium of claim 65, wherein the program instructions are further computer-executable to implement displaying on the first device a graphical user interface to the traditional instrument coupled to the second device, wherein the graphical user interface is operable by the user to remotely control functionality of the traditional instrument from the second device.

67. The carrier medium of claim 65, wherein the program instructions are further computer-executable to implement:
the first device receiving the instrument data from the instrument server via the network; and
displaying the received instrument data on the first device

68. A carrier medium comprising program instructions, wherein the program instructions are computer-executable to implement:
scanning an instrumentation bus coupled to a first device to detect instruments coupled to the instrumentation bus;
said scanning detecting a first traditional instrument coupled to the instrumentation bus, wherein the first traditional instrument does not include inherent Internet capabilities;
receiving instrument information from the detected first traditional instrument;
providing the instrument information of the first traditional instrument to a second device coupled to the first device via a network; and
displaying the instrument information of the first traditional instrument on the second device;
wherein the first traditional instrument coupled to the first device via the instrumentation bus is remotely accessible from the second device to initiate monitor and control functions of the first traditional instrument.

69. The carrier medium of claim 68, wherein the program instructions are further computer-executable to implement:
receiving user input on the second device, wherein the user input specifies the first traditional instrument; and
sending a request to access the first traditional instrument from the second device to the first device through the network in response to the user input.
